(19) United States
(12) Patent Application Publication
(10) Pub. No.: US 2026/0132875 A1
(43) Pub. Date: May 14, 2026

(54) Fitting for the Connection of Two Tubular Elements and Method for the Production Thereof

(71) Applicant: I.M.M. Hydraulics S.p.A., Atessa (IT)

(72) Inventor: Domenico Vizzarri, Atessa (IT)

(73) Assignee: I.M.M. Hydraulics S.p.A., Atessa, CH (IT)

(21) Appl. No.: 19/118,396

(22) PCT Filed: Oct. 4, 2023
(86) PCT No.: PCT/IB2023/059963

§ 371 Date: Apr. 4, 2025

(30) Foreign Application Priority Data
Oct. 5, 2022 (IT) 102022000020499

(51) Int. Cl. F16L 33/22

(52) U.S. Cl. CPC F16L 33/223

(57) ABSTRACT

A fitting for the connection of two tubular elements is provided that includes an inner sleeve provided with two outer coupling flanges, and a locking nut provided with a hooking flange having, in an initial configuration, an inner diameter that is greater than an outer diameter of the coupling flange so as to allow the locking nut to slide along the inner sleeve and, in a final configuration, an inner diameter that is smaller than the outer diameter of the two coupling flanges so as to allow the hooking flange to be axially locked between the coupling flanges.

### CROSS-REFERENCE TO RELATED APPLICATIONS

This Patent Application claims priority from Italian Patent Application No. 102022000020499 filed on Oct. 5, 2022, the entire disclosure of which is incorporated herein by reference.

### TECHNICAL FIELD

This invention relates to a fitting for the connection of two tubular elements.

### BACKGROUND

In particular, this invention relates to a fitting for the connection of two tubular elements of the type comprising an inner sleeve, which has a longitudinal axis, and is delimited, axially, by a first end face and a second end face that are opposite to each other.

The inner sleeve comprises a first portion, which extends starting from the first end face, and is designed to receive and hold a first tubular element, and a second portion, which extends starting from the second end face, and is provided, normally, with an outer coupling flange.

Generally, the first portion of the inner sleeve is delimited by an outer side surface with a conical shape provided with multiple annular teeth, which extend around the above-mentioned longitudinal axis, and are distributed along the longitudinal axis.

The fitting further comprises a locking nut, in particular a hexagonal one, which is designed to receive and hold a second tubular element, and is provided with an inner hooking flange.

The locking nut is fitted around the inner sleeve starting from the first end face, is moved forward along the inner sleeve so as to move the hooking flange substantially in contact with the coupling flange, and is axially locked on the inner sleeve using a locking ring.

The known fittings for the connection of two tubular elements of the type described above have some drawbacks, mainly deriving from the fact that the presence of the inner sleeve, the locking nut, and the locking ring entails a relatively large number of components.

### SUMMARY

The object of this invention is to provide a fitting for the connection of two tubular elements that is free of the drawbacks described above and is simple and economical to manufacture.

According to this invention, a fitting for the connection of two tubular elements is provided as claimed in claims 1 to 3.

This invention further relates to a method for the manufacture of a fitting for the connection of two tubular elements.

According to this invention, a method for the manufacture of a fitting for the connection of two tubular elements is provided as claimed in claims 4 to 8.

### BRIEF DESCRIPTION OF THE DRAWINGS

This invention will now be described with reference to the attached drawings, which illustrate a non-limiting embodiment thereof, in which:

FIG. 1 is a schematic side view, with parts in cross-section, of a preferred embodiment of the fitting of this invention;

FIG. 2 is a schematic side view, with parts in using the fitting in FIG. 1; and

FIG. 3 schematically illustrates the method for manufacturing the fitting in FIG. 1.

### DESCRIPTION OF EMBODIMENTS

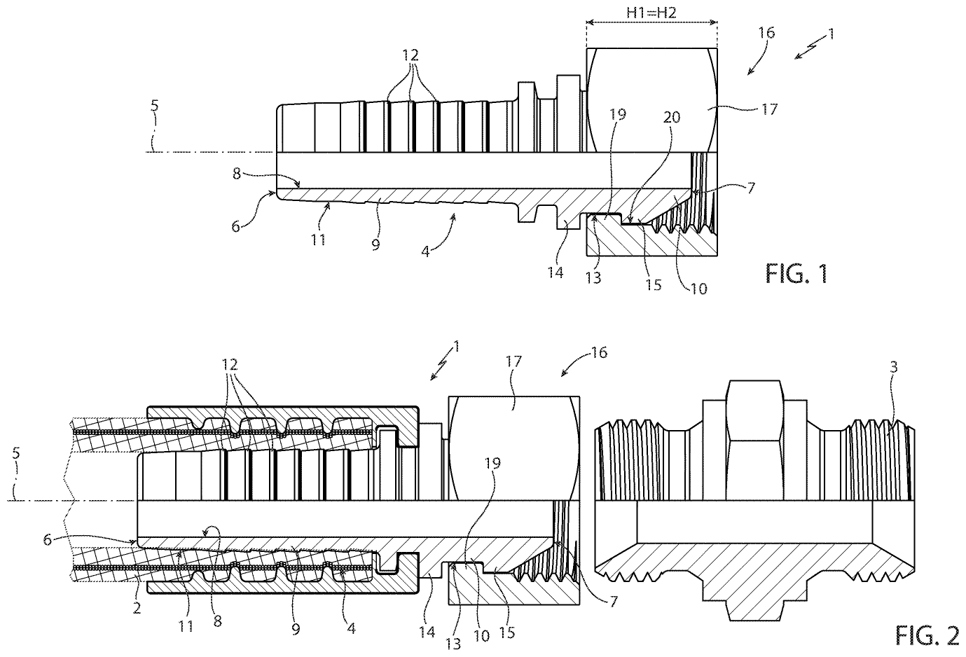

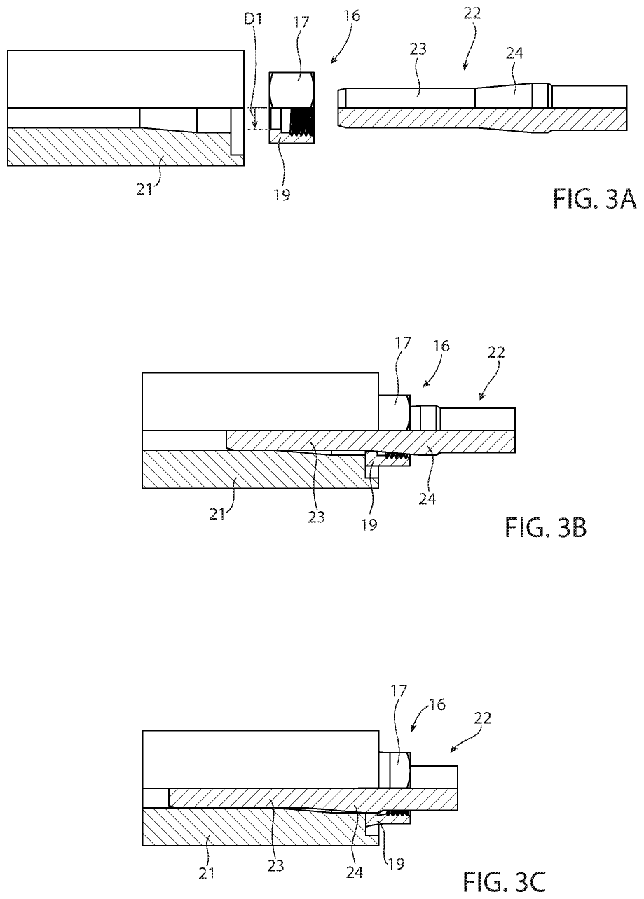

With reference to FIGS. 1 and 2, reference number 1 indicates, as a whole, a fitting for connecting two tubular elements 2, 3 together.

The fitting 1 comprises an inner sleeve 4, which has a longitudinal axis 5, and is delimited axially by two end faces 6, 7 substantially perpendicular to the axis 5.

The sleeve 4 is delimited by an inner surface 8 with a cylindrical shape that is coaxial to the axis 5, and comprises a first portion 9, which extends starting from the face 6, and is designed to receive and hold a first tubular element 2, and a second portion 10, extending starting from the face 7.

The surface 8 is smooth and has no cavities, in particular annular, and ensures the sleeve 4 has a relatively high resistance.

The portion 9 is delimited by an outer surface 11, which has a conical shape, and is provided with a plurality of annular teeth 12, which extend around the axis 5, and are distributed along the axis 5.

The portion 10 is delimited by an outer surface 13 that is coaxial to the axis 5, and is provided with a first coupling flange 14, which radially projects outside from the surface 13, and consists of a single piece with the sleeve 4.

The portion 10 is further provided with a second coupling flange 15, which is formed between the face 7 and the first flange 14, radially projects outside from the surface 13, and consists of a single piece with the sleeve 4.

The fitting 1 comprises a locking nut 16, which has a hexagonal shape, is designed to receive, and hold a second tubular element 3, and is delimited by a plurality of outer locking faces 17, in this case six faces 17.

According to some variants not shown, the nut 16 has a number of faces 17 other than six, for example from four to eight.

The faces 17 have a height H1, measured parallel to a longitudinal axis 18 of the nut 16, equal to a height H2 of the nut 16, which is also measured parallel to the axis 18. The nut 16 is provided with an inner hooking flange 19, which radially projects inside from an inner surface 20 of the nut 16, consists of a single piece with the nut 16, and is made at one end of the nut 16.

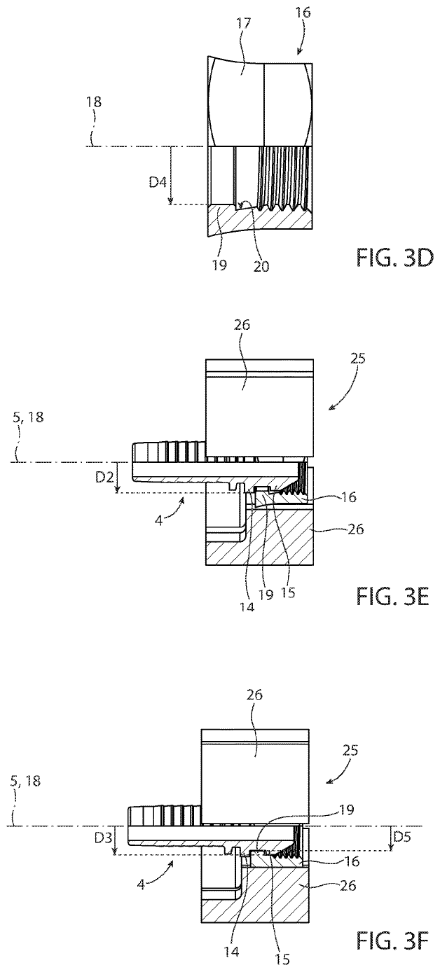

According to what is shown in FIG. 3, the flange 19 has an initial inner diameter D1 (FIG. 3a) that is smaller than an outer diameter D2 of the flange 14 (FIG. 3e) and an outer diameter D3 of the flange 15 (FIG. 3f). The nut 16 is axially locked in a matrix 21, and the flange 19 is widened using the insertion of a punch 22 in the nut 16 and in the matrix 21 (FIGS. 3a, 3b, and 3c).

With regard to the above description, it should be noted that the punch 22 comprises a guide portion 23 having a diameter approximating, rounding down, the inner diameter D1, and a widening portion 24, which has a truncated cone shape, and is designed to engage the flange 19 and to widen it to an intermediate inner diameter D4 (FIG. 3d) that is greater than the outer diameter D3 of the flange 15.

At this point, the nut 16 is inserted on the sleeve 4 starting from the face 7 and is moved along the sleeve 4 so as to arrange the flange 19 between the two flanges 14, 15 (FIG. 3e).

Finally, the nut 16 is deformed at least at the flange 19 using a pressing device 25 comprising at least two pressing elements 26, which are uniformly distributed around the axis 18, and are mobile transversely to the axis 18 to compress the nut 16 and deform the flange 19 to a final inner diameter D5 that is smaller than the outer diameters D2, D3 of the flange 14, 15 (FIGS. 3e and 3f). As a result, the nut 16 is axially locked along the sleeve 4 by the engagement of the flange 19 between the flanges 14, 15 and the fitting 1 has a relatively small number of components.

According to a variant not shown, the nut 16 is, in the first place, manufactured, for example via moulding, so as to have, in an initial configuration, the intermediate inner diameter D4, and is, thus, deformed by the pressing device 25 so as to have, in a final configuration, the final inner diameter D5.

1. (canceled)

2. (canceled)

3. (canceled)

4. A method for the manufacture of a fitting for the connection of two tubular elements (2, 3), the fitting comprising an inner sleeve (4), which has a longitudinal axis (5), is axially delimited by two end faces (6, 7) and comprises, in turn, a first portion (9), which extends starting from a first end face (6) and is designed to receive and hold a first tubular element (2), and a second portion (10), which extends starting from a second end face (7) and is provided with a first outer coupling flange (14) manufactured as one single piece with the inner sleeve (4); and a locking nut (16), in particular a hexagonal one, which is designed to receive and hold a second tubular element (3) and is provided with an inner hooking flange (19); the method comprising the steps of:
obtaining, on the inner sleeve (4), a second outer coupling flange (15), which is arranged between the first coupling flange (14) and the second end face (7) and is manufactured as one single piece with the inner sleeve manufacturing the locking nut (16) so that the hooking flange (19) has, in an initial configuration, an inner diameter (D4) that is greater than an outer diameter (D3) of the second coupling flange (15);
inserting the locking nut (16) along the inner sleeve (4) starting from the second end face (7) so as to place the hooking flange (19) between the two coupling flanges (14, 15); and
deforming the locking nut (16) so that the hooking flange (19) has, in a final configuration, an inner diameter (D5) that is smaller than the outer diameter (D2, D3) of the two coupling flanges (14, 15) so as to allow the hooking flange (19) to be axially locked between the coupling flanges (14, 15);
wherein:
the initial configuration of the locking nut (16) is obtained by widening the hooking flange (19) from a first inner diameter (D1), which is smaller than the outer diameter (D2, D3) of the two coupling flanges (14,15), to a second inner diameter (D4), which is greater than the outer diameter (D3) of the second coupling flange (15); and
the locking nut (16) is delimited by a plurality of outer locking faces (17), which have a height (H1), measured parallel to the longitudinal axis (5) of the inner sleeve (4), equal to a height (H2) of the locking nut (16), also measured parallel to the longitudinal axis (5) of the inner sleeve (4).

5. (canceled)

6. (canceled)

7. The method accourdin go claim 1, wherein the hooking flange (19) is widened by inserting a punch (22) into the locking nut (16).

8. The method according to claim 1, wherein the final configuration of the locking nut (16) is obtained by means of a pressing device (25) mounted on the outside of the locking nut (16) and comprising at least two pressing elements (26), which are movable crosswise to a longitudinal axis (18) of the locking nut (16) in order to deform the hooking flange (19).

9. (canceled)

10. The method according to claim 1, wherein the inner sleeve is delimited by an inner cylindrical surface (8), which is smooth and has no cavities.
